(19) United States
(12) Patent Application Publication
(10) Pub. No.: US 2015/0201804 A1
(43) Pub. Date: Jul. 23, 2015

(54) BBQ GRILL

(71) Applicant: KUO-YI LIAO, Taoyuan (TW)

(72) Inventor: KUO-YI LIAO, Taoyuan (TW)

(21) Appl. No.: 14/159,441

(22) Filed: Jan. 21, 2014

(51) Int. Cl. A47J 37/07

(52) U.S. Cl. CPC A47J 37/07

(57) ABSTRACT

A BBQ grill has an upper grill layer, a lower grill layer and a barrel body. The upper grill layer respectively has a positioning rod on three sides except one side connected to a handle provided with a spring element, the positioning rod is corresponding to a securing socket on the lower grill layer, and the lower grill layer is disposed on a top surface of the barrel body. The positioning rods of the upper grill layer can individually engage with the securing socket of the lower grill layer to enable rotation movements.

### BACKGROUND OF THE INVENTION

1. Field of the Invention

The present invention relates to a BBQ grill, and more particularly to a BBQ grill capable of being rotated in different directions.

2. Description of Prior Art

Various cooking methods from different counties can provide different food experiences. One of the well-known method is BBQ, which requires BBQ grill and charcoal. However, conventional BBQ grills are not suitable for larger size food material.

Therefore, it is desirable to provide a BBQ grill to mitigate and/or obviate the aforementioned problems.

### SUMMARY OF THE INVENTION

In order to achieve the above-mentioned objective, a BBQ grill comprises an upper grill layer, a lower grill layer and a barrel body.

Furthermore, the upper grill layer respectively has a positioning rod on three sides except one side connected to a handle provided with a spring element, the positioning rod is corresponding to a securing socket on the lower grill layer, the lower grill layer is disposed on a top surface of the barrel body.

Another objective of the present invention is to provide a BBQ grill comprising: a cover, a disk and a barrel body.

### BRIEF DESCRIPTION OF THE DRAWINGS

FIG. 1 is a perspective view of a BBQ grill according to an embodiment of the present invention.

FIG. 2 is a cross-sectional view of a barrel body of the BBQ grill according to the embodiment of the present invention.

FIG. 3 is a perspective view of an upper grill layer of the BBQ grill according to the embodiment of the present invention,

FIG. 4A is a perspective view of the upper grill layer and a lower grill layer according to the embodiment of the present invention.

FIG. 4B is another perspective view of the upper grill layer and a lower grill layer according to the embodiment of the present invention,

FIG. 5 is a perspective view of the upper grill layer and a lower grill layer according to another embodiment of the present invention,

FIG. 6 is a perspective view of a barrel body according to another embodiment of the present invention.

### DETAILED DESCRIPTION OF THE INVENTION

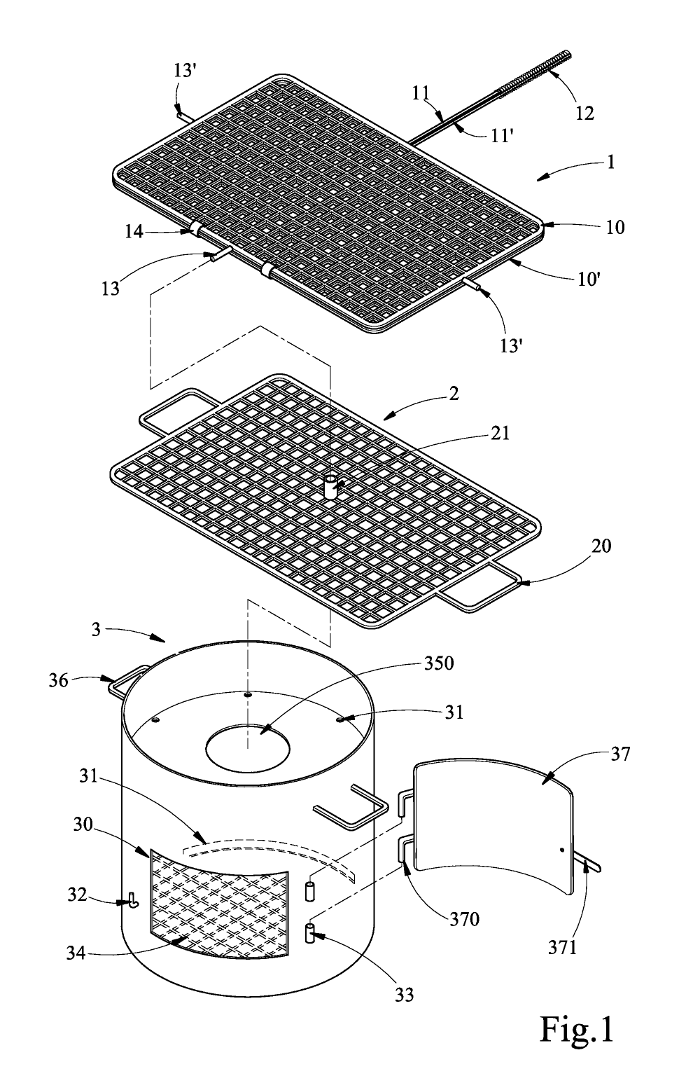

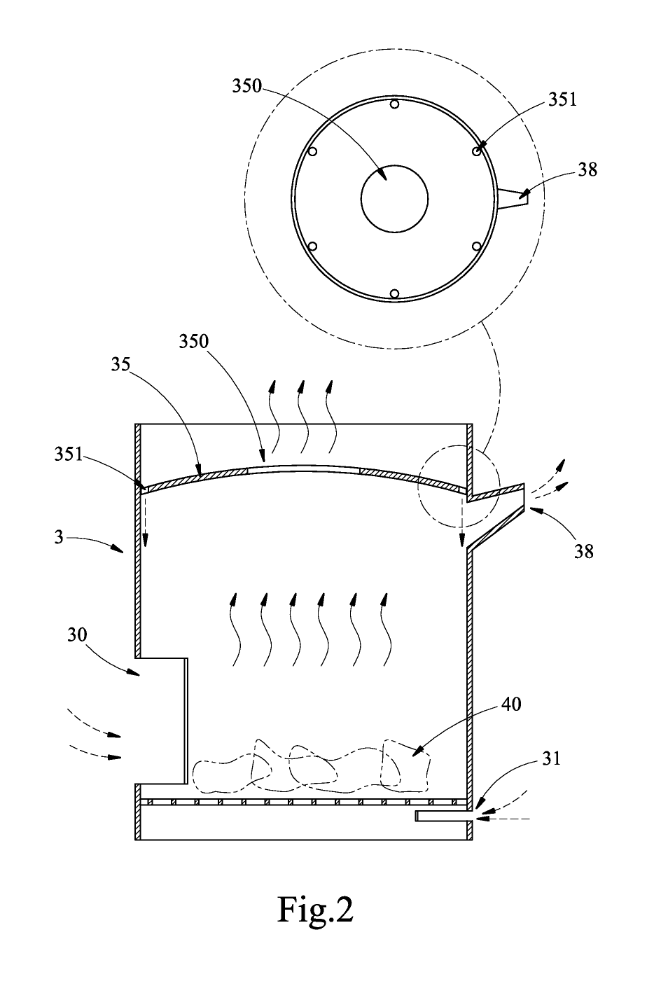

Please refer to FIG. 1 and FIG. 2. A BBQ grill comprises an upper grill layer 1, a lower grill layer 2 and a barrel body 3. The upper grill layer 1 is composed of two overlapped rectangular grid members 10, 10′ secured together by a locking member 14 at one edge side, such as the grid members 10, 10′ can be opened away from each other. The two grid members 10, 10′ are further respectively provided with a handle 11, 11′ at an opposite edge side. The handles 11 is shorter than the handle 11′, and one end of the handle 11′ is provided with a spring element 12. The grid members 10, 10′ both further respectively have a positioning rod 13, 13′ on each three edges other than the edge with the handle 11, 11′, which are corresponding to a securing socket 21 of the lower grill layer 2. The lower grill layer 2 is rectangular an provided with the securing socket 21 and two grips 20 on two opposite sides. The securing socket 21 is configured to accept the positioning rods 13, 13′ of the upper grill layer 1. Also, the lower grill layer 2 is disposed at a top surface of the barrel body 3.

The barrel body 3 has a net member 34 disposed cross a lower intersection and an arched dividing board 35 disposed cross an upper intersection. The dividing board 35 is provided with a center hole 350 and a plurality of apertures 351 disposed evenly around the peripheral. Furthermore, an outlet nose 381 is formed at an upper position on the outer peripheral of the barrel body 3 (please refer to FIG. 2), and a longitude through slot 31 is disposed directly below the outlet nose 38 and the net member 34. Moreover, an opening 30 is disposed on the barrel body 3 opposite than the longitude through slot 31 above the net member 34, and the opening 30 is provided with a first securing member 32 and a first positioning member 33 at two opposite sides. The first positioning member 33 is configured to engage with a second positioning member 370 of a cover 37, and the first securing member 32 is configured to engage with a second securing member 371 of the cover 37. Furthermore, two holders 36 are disposed oppositely on the barrel body 3. The opening 30 of the barrel body 3 is configured for accepting burning agent 40, with the air flow provided by the through slot 31, the generated heat can pass through the center hole 350 of the dividing board 35. The apertures 351 of the dividing board 35 can allow the grease from food to exit. The outlet nose 38 releases the exhaust, and the top surface of the barrel body 3 is configured for placing the lower grill layer.

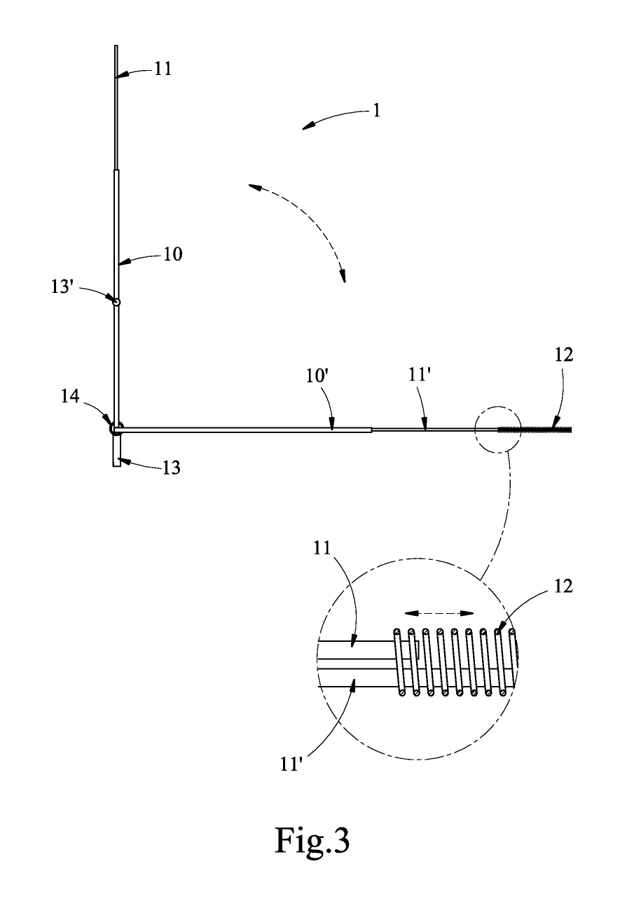

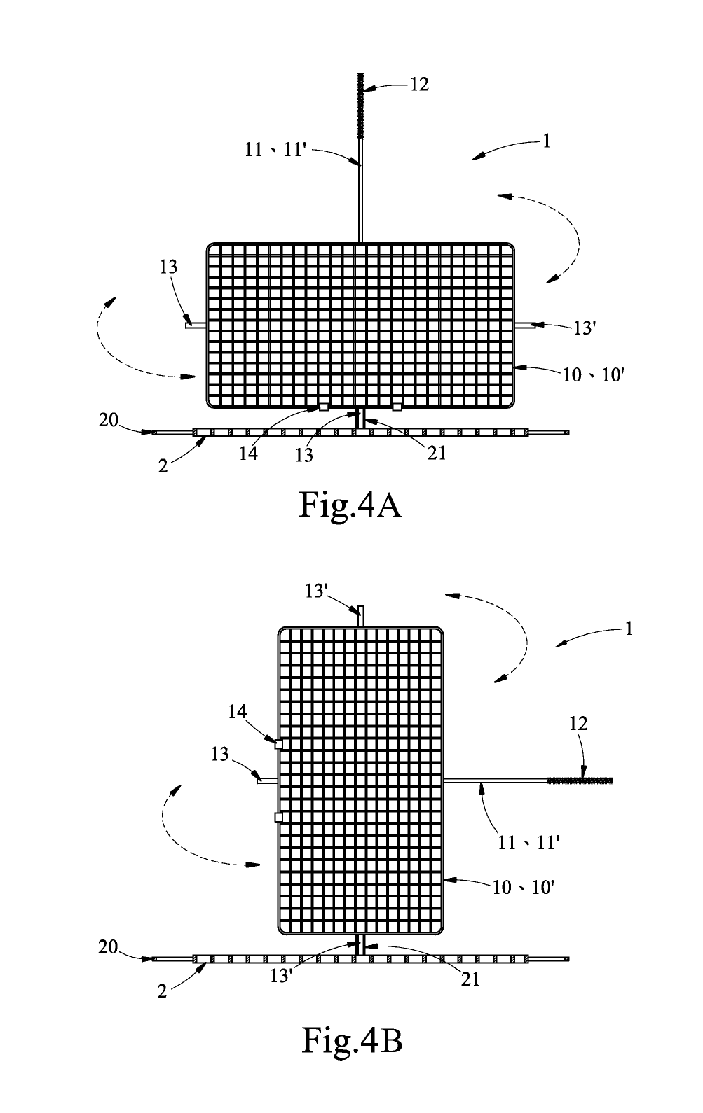

Please refer to FIG. 3, FIG. 4A and FIG. 4B. The upper grill layer 1 is composed of two overlapped rectangular grid members 10, 10′ secured together by a locking member 14 at one edge side, such as the grid members 10, 10′ can be opened away from each other. The two grid members 10, 10′ are further respectively provided with a handle 11, 11′ at an opposite edge side. The handles 11 is shorter than the handle 11′, and one end of the handle 11′ is provided with a spring element 12. The grid members 10, 10′ both further respectively have a positioning rod 13, 13′ on each three edges other than the edge with the handle 11, 11′, which are corresponding to a securing socket 21 of the lower grill layer 2. As shown in FIG. 4A and FIG. 4B, the positioning rods 13, 13′ of the upper grill layer 1 can individually engage with the securing socket 21 of the lower grill layer 2 to enable rotation movements.

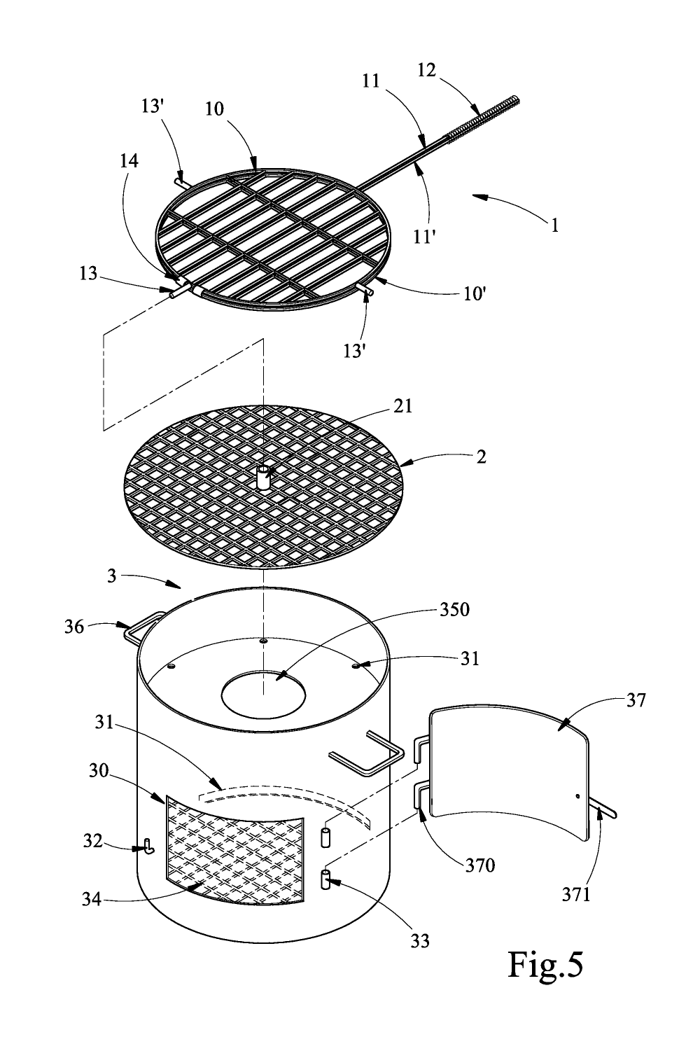

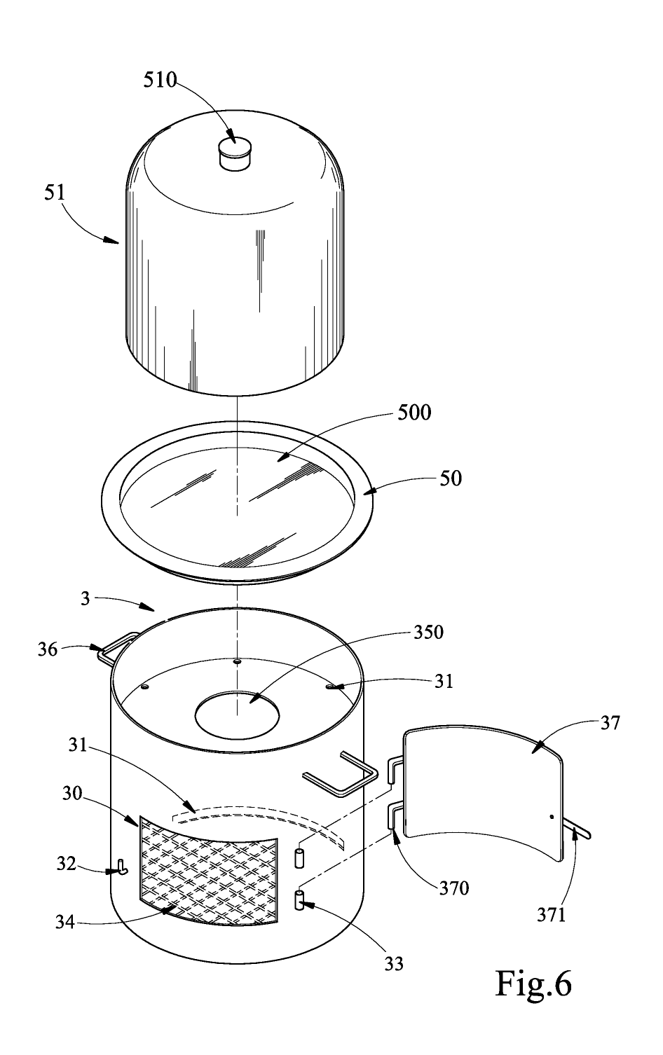

Please refer to FIG. 5 and FIG. 6. The upper grill layer 1 and the lower grill layer 2 are disposed above the barrel body 3, and the upper grill layer 1 and the lower grill layer 2 can be rectangular or circular shapes.

Alternatively, a disk 50 with a containment space 500 is disposed above the barrel body 3, and a cover 51 with a handle 510 is provided to cover the disk 50. This design can provide more various cooking methods.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A BBQ grill comprising an upper grill layer, a lower grill layer and a barrel body, and it characterized in:
the upper grill layer respectively has a positioning rod on three sides except one side connected to a handle provided with a spring element; the positioning rod is corresponding to a securing socket on the lower grill layer; the lower grill layer is disposed on a top surface of the barrel body.

2. The BBQ grill as claimed in claimed in claim 1, wherein the securing socket of the lower grill layer is disposed on a surface.

3. The BBQ grill as claimed in claimed in claim 1, wherein the upper grill layer might have a rectangular shape or a circular shape.

4. The BBQ grill as claimed in claimed in claim 1, wherein the lower grill layer might have a rectangular shape or a circular shape.

5. A BBQ grill comprising: a cover, a disk and a barrel body, and it characterized in:
the cover is corresponding to a containment portion of the disk, the disk is disposed on a top surface of the barrel body.

6. The BBQ grill as claimed in claimed in claim 5, wherein the cover and the disk are also configured to be installed onto a gas stove.
